(19) United States
(12) Patent Application Publication
(10) Pub. No.: US 2005/0013883 A1
(43) Pub. Date: Jan. 20, 2005

(54) Method for treating peach trees for peach leaf curl disease

(76) Inventor: Jack L. Becker, Westlake Village, CA (US)

Correspondence Address: MORLAND C FISCHER, 2030 MAIN ST, SUITE 1050, IRVINE, CA, 92614, US

(21) Appl. No.: 10/623,213

(22) Filed: Jul. 18, 2003

(51) Int. Cl. A01N 31/00; A01N 31/08; A01N 65/00

(52) U.S. Cl. 424/745; 514/729

(57) ABSTRACT

A safe and natural method to cure the fungal disease caused by the Taphrina deformans fungus known as peach leaf curl. This disease commonly effects and destroys the leaves and fruits of peach and nectarines trees. According to the present discovery, it has been found that Carvacrol, a constituent of the extracts derived from oregano and thyme plants, is an effective agent to eradicate peach leaf curl during the season of infection. Several (e.g., two or three) applications of an aqueous solution containing oregano oil or thyme oil (known commercially as Oil of Oregano and Oil of Thyme) has been found to cure the infected trees and save the current year's fruit crop for harvest.

### BACKGROUND OF THE INVENTION

1. Field of the Invention

This invention relates to an effective method for preventing and treating the fungal disease peach leaf curl which is known to attack and destroy the leaves and fruit of peach and nectarine trees. The method herein described has proven effective in curing the disease during the growing season even after young leaves have already been infected and buds are in bloom.

2. Background Art

Much has been written about the fungal disease caused by the Taphrina deformans fungus and commonly known as peach leaf curl. Peach leaf curl is a relatively common and widespread disease effecting peach and nectarine trees that first appears in early spring, particularly in relatively cool, wet weather. Peach leaf curl usually causes new leaves of infected trees to curl or crinkle as they first unfurl in spring. Some or all of the leaves may become infected. The infected leaves first become thickened and often turn red or purple. Later in the season, after fungal spores are produced on the leaf surface, the leaves turn silvery or gray and appear powdery. Eventually, the diseased leaves may turn yellow or brown. Many of the diseased leaves ultimately die and fall off the tree. Consequently, the tree is weakened so as to become susceptible to other diseases during winter with the prospect of producing a reduced or poor fruit yield for the current and following years. Failure to control the disease for several years can kill the tree.

It is generally known that peach leaf curl can be controlled by the application of an appropriate fungicide. A 2003 Newsletter Update issued by the Horticulture Department of Kansas State, University Research And Extension recommended dormant sprays containing ferbam, chlorothalonil (Daconil), Bordeaux or liquid lime sulfur. However, the Newsletter noted that the timing of the fungicide is extremely important, such that the disease cannot be controlled once the leaves have started to expand.

A 2003 Newsletter Release from the University of Nebraska, Lincoln, noted that peach leaf curl can be effectively prevented by a single application of lime sulfur, chlorothalonil, Bordeaux mixture, or a copper fungicide. However, it was once again recognized that timing of the application was critical, because the infection occurs when the buds begin to swell. Therefore, the fungicide must be applied during the dormant season (i.e., in the fall through late winter).

A University of Massachusetts Fruit Advisor (Extension Fact Sheet F-200) recommended chlorothalonil or copper compounds (K ocide, COCS, etc.) as the most effective fungicides to prevent an outbreak of peach leaf curl. Ziram, lime sulfur and Bordeaux were considered useful, but less effective treatments. However, it was again noted that once the fungal infection is visually detected, it is too late to cure the disease. That is, a fungal spray should be applied in the autumn after leaf fall or in the early spring prior to bud swell. Once a leaf curl epidemic occurs, the only treatment is to minimize stress on the infected trees (e.g., by means of extra fertilizer, irrigation and removing the fruit load), inasmuch as none of the aforementioned fungicides will be effective following infection.

Likewise, in a Nov. 24, 1999, Home, Yard & Garden Pest Newsletter, spraying a suitable fungicide (e.g., Spectro by Cleary, Bordeaux mix, copper fungicides, lime sulfur and sulfur) on peach trees was recommended as a suitable measure to control peach leaf curl. Like the articles described above, treatment was recommended when the trees are dormant (i.e., before the problem occurs), because no rescue treatment is known during the growing season. In other words, the long standing perception is to kill the Taphrina deformans fungus as it overwinters on the twigs and bud scales.

An Apr. 13, 2001 article from the Horticulture & Home Pest News prepared for the Department of Plant Pathology of Iowa State University recommended the same fungicide treatments as those listed above as an effective means to control peach leaf curl. In this same regard, it was also recognized that once the leaves become infected, they can no longer be treated that year, with the result that infected trees are likely to experience early leaf drop, a reduced fruit crop, and exposure to other stress.

In an Online Guide to Plant Disease Control, originally published by Oregon State University Extension in 1954, fungicide applications of the following chemicals were recommended to control peach leaf curl: Bordeaux mixture, Bravo Weather Silk, copper based fungicides, Daconil Lawn and Garden Fungicide, Echo 720, Ferbam Granuflo, lime sulfur, syllit 65 WP, Thiram Giranuflo, and Zirum 76 DF or Zirum Granuflo.

Finally, in an article issued by the Department of Plant Pathology and Ecology of the Connecticut Agricultural Experiment Station, ferbam and fixed copper have been suggested as suitable fungicides to arrest peach leaf curl.

All of the articles listed above clearly recognize that there is no effective fungicide or other treatment available to control peach leaf curl as the trees are growing and in tender foliage (i.e., with buds swelling). Instead, diseased trees must be treated during the dormant season in late autumn through early spring before the buds begin to swell. Consequently, the crop of fruit for the current growing year is lost to the disease. It would therefore be desirable to have available a safe and effective treatment for peach leaf curl that could be used during the spring and while fruit is forming so as to eliminate the disease and save the current crop for human consumption.

### SUMMARY OF THE INVENTION

A safe and natural method is disclosed for curing the fungal disease caused by the Taphrine deformans fungus and known as peach leaf curl. This disease has commonly attacked and destroyed the leaves and fruit of peach and nectarine trees leaving the trees susceptible to other diseases. The only effective treatment heretofore available has been to apply a chemical based fungicide during the dormant season (from late fall through late winter or early spring). In this case, most of the fruit crop of the infected trees will be lost to the disease.

According to the present method, it has been discovered that Carvacrol can effectively treat peach and nectarine trees and cure peach leaf curl during the season of infection so as to save the current fruit crop for harvest. Carvacrol is a constituent of the extracts derived from oregano and thyme plants. More particularly, several (e.g., two or three) heavy doses of Carvacrol by way of oregano oil (sold commercially as Oil of Oregano) or thyme oil (sold commercially as Oil of Thyme) to the infected trees has been found to cure the trees without the use of chemical fungicides. A solution containing about 6-7 ml Oil of Oregano or 7.5-8.5 ml Oil of Thyme and one gallon of water can be sprayed onto the infected trees to kill the fungus so that new leaves will retain their full green color and blooming buds will blossom into fruit as if no infection had occurred.

### DETAILED DESCRIPTION

The present method allows growers to have a natural and effective treatment to eradicate the fungal disease known as peach leaf curl. This new treatment can be applied (e.g., sprayed) during spring at the same time that new fruit is forming from swelling buds. Thus, the entire yield of a peach tree can be salvaged and harvested while avoiding the heretofore deleterious effects of peach leaf curl on the current season's crop. That is to say, a peach tree can now be treated while infected, as opposed to having to postpone treatment until the dormant season with the consequences that most or all of the current year's crop will fail to mature and the tree will become prematurely defoliated. Moreover, the newly proposed treatment has proven successful so that new leaves will retain their normal green color and the fruit will ripen on schedule so as to be suitable for consumption.

More particularly, it has been found that a solution containing Carvacrol (an isomeric phenol) will successfully treat peach trees that have already been infected with peach leaf curl. Carvacrol, or isopropyl-o-cresol, is the principal constituent of oil of oregano. Carvacrol can also be prepared from carvone by treatment with acids or by heating camphor with iodine. Carvacrol occurs as a thick colorless oil that solidifies when cooled to a low temperature. Carvacrol is characterized as a powerful antiseptic, but only for human use.

Carvacrol occurs naturally in oregano (origanum vulgare). Oregano is recognized as a powerful anti-fungal in humans. Because of its germ killing ability, oregano has proven particularly useful when working in the GI tract as well as in the sinuses and the lungs. It is reported that oregano has stopped the production of a cancer causing fungal toxin aflatoxin. Yeast species have not demonstrated a resistance to oregano. It has also been reported that oregano will exhibit anti-bacterial action against certain bacteria known to cause human illness and death, and oregano oil is one of the strongest natural germ killing agents currently available.

Oregano oil has become the agent of choice is combating both fungal and bacterial maladies in humans and has regularly been used for head colds, coughs, sinus problems, bronchitis and pneumonia. In this regard, while oregano and oregano oil have exhibited beneficial characteristics as a homeopathic anti-fungal, such benefits have been limited entirely to the treatment of humans. However, nothing is known to apply oregano oil or the Carvacrol constituent thereof to plants, in this case, to peach trees, for the specific purpose of eradicating peach leaf curl.

Accordingly, it has been discovered that oregano oil or, as it is known commercially, Oil of Oregano can be sprayed onto peach trees to effectively treat peach leaf curl, even while the tree is infected. Oil of Oregano is pure oregano extract diluted with a passive or base oil such as olive oil or the like. More particularly, it has been found that several (e.g., two or three) heavy doses of solution containing Oil of Oregano and water combined in a ratio of about 6-7 ml Oil of Oregano to one gallon of water has cured the trees and enabled new leaves to obtain full color and growth as if no infection had initially occurred.

It can be appreciated that Oil of Oregano is herbal rather than chemical. Therefore, and unlike the known chemical fungicide described above, the newly discovered treatment can be considered natural. Accordingly, this discovery provides both a safe and effective cure for peach leaf curl while acting immediately to prevent further damage to the tree and save the current year's fruit crop for harvest.

Carvacrol is also found in thyme plants (thymus vulgaris). The leaves of thyme have a unique fragrance which is caused by an essential oil. The extract from thyme plants is also known that have homeopathic medicinal advantages.

Thyme oil can be obtained for commercial use by distillation of the fresh leaves and flowering tops of the thyme plants. One of the chief constituents of thyme oil is Carvacrol. Spanish thyme oil is known to contain a high percentage of phenols, especially Carvacrol. The medicinal attributes of thyme oil have been used in applications relating to antiseptics, antispasmodics, tonics and carminatides.

However, like oregano oil, the use of thyme oil (or Oil of Thyme as it is known commercially) as a medicinal agent has been limited entirely to treating humans. Nothing is known to apply thyme oil to peach trees to eradicate peach leaf curl. Although Oil of Thyme contains about 25% less Carvacrol than Oil of Oregano, the method described herein also extends to spraying Oil of Thyme and the Carvacrol constituent thereof onto peach trees to treat peach leaf curl. Oil of Thyme includes a passive or base oil to dilute pure thyme extract. Like the Oil of Oregano earlier disclosed, several (e.g., 2 or 3) heavy doses of solution containing Oil of Thyme and water combined in a ratio of about 7.5-8.5 ml Oil of Thyme to one gallon of water will be effective to cure infected trees and enable a substantially complete harvest of fruit by natural rather than chemical means.

While it has been disclosed herein to apply Oil of Oregano and Oil of Thyme to peach trees to treat peach leaf curl, it is to be expressly understood that this same treatment is also applicable to nectarine trees. In this same regard, it is believed that the present method will be effective with almond trees as well.

1. A method for treating peach and nectarines trees infected with the fungal disease peach leaf curl caused by the Taphrina deformans fungus, said method including the steps of applying Carvacrol to the infected trees to cure the disease.

2. The method recited in claim 1, including the additional step of applying the Carvacrol while the trees are infected so as to cure the disease and thereby save the current year's fruit crop.

3. The method recited in claim 1, including the additional step of applying the Carvacrol to the infected trees in the form of oregano oil.

4. The method recited in claim 1, including the additional step of applying the Carvacrol to the infected trees in the form of thyme oil.

5. The method recited in claim 1, including the additional step of applying the Carvacrol as a spray containing water according to the ratio of 6-7 ml Oil of Oregano for each gallon of water.

6. The method recited in claim 1, including the additional step of applying the Carvacrol as a spray containing water according to the ratio of 7.5-8.5 ml Oil of Thyme for each gallon of water.
